(19) United States
(12) Patent Application Publication
(10) Pub. No.: US 2020/0341972 A1
(43) Pub. Date: Oct. 29, 2020

(54) ASYNCHRONOUS DATA UPDATES WITH READ-SIDE FILTERING

(71) Applicant: Microsoft Technology Licensing, LLC, Redmond, WA (US)

(72) Inventors: Issac Buenrostro, Sunnyvale, CA (US); Anthony Hsu, Sunnyvale, CA (US); Hung V. Tran, Union City, CA (US); Sudarshan Vasudevan, Mountain View, CA (US); Lei Sun, Sunnyvale, CA (US); Jack W. Moseley, Sunnyvale, CA (US); Shirshanka Das, San Jose, CA (US); Vasanth Rajamani, Burlingame, CA (US)

(21) Appl. No.: 16/425,688

(22) Filed: May 29, 2019

Related U.S. Application Data
(60) Provisional application No. 62/839,249, filed on Apr. 26, 2019.

(51) Int. Cl. G06F 16/23; G06F 16/2455; G06F 16/2453; G06F 16/27

(52) U.S. Cl. CPC G06F 16/2386; G06F 16/24561; G06F 16/273; G06F 16/2358; G06F 16/24534

(57) ABSTRACT

The disclosed embodiments provide a system for managing a data store. During operation, the system stores a set of pending updates to a data store in a registry. Next, the system executes an asynchronous process that applies a first subset of updates from the registry as writes to records in the data store without blocking processing of read queries of the data store. Upon completing a write by the asynchronous process at a second portion of the data store, the system updates the registry with an indication of the completed write at the second portion of the data store. During processing of a read query of the data store, the system applies a second subset of updates from the registry to a result of the read query. Finally, the system returns the result in a response to the read query.

### RELATED APPLICATION

This application hereby claims priority under 35 U.S.C. § 119 to U.S. Provisional Application No. 62/839,249, entitled “Asynchronous Bulk Data Updates with Read-Side Filtering,” filed 26 Apr. 2019 (Atty. Docket No. LI-902543-US-PSP), which is incorporated by reference herein.

### BACKGROUND

### Field

The disclosed embodiments relate to bulk data updates. More specifically, the disclosed embodiments relate to techniques for performing asynchronous bulk data updates with read-side filtering.

### Related Art

Organizations with large numbers of users often store and/or manage large volumes of data for the users. For example, an online network with hundreds of millions of members can maintain on the order of petabytes (PB) of data related to the members' profiles and/or activity.

At times, bulk updates to user data and/or other types of data are required for compliance with regulations and/or policies. For example, search data, location data, personally identifiable information (PII), and/or other fields in a dataset require obfuscation and/or transformation to comply with privacy and/or opt-out preferences for the corresponding users.

On the other hand, data stores typically lack built-in support for such large-scale bulk data updates. First, relational database management systems (RDBMS) allow for updates to records on tables up to a few terabytes in size. Because RDBMSes have strong consistency requirements, updates of large amounts of data (>1 TB) take a very long time, which reduces large-scale update queries per second (QPS) and potentially affects reads. Additionally, increasing the efficiency of these updates generally requires having indexes or convenient structure on the data.

Second, data lakes are largely unstructured. Although some metadata is known about files or blobs in a data lake, the blobs are relatively disorganized and unindexed. Updates affecting multiple tables or datasets in a data lake are extremely costly, leading to long latencies on the application of the updates and potential inconsistencies in the data during the application. Additionally, data lakes tend to hold immutable blobs, so an update requires rewriting at least entire blocks within blobs.

Third, distributed key-value stores allow for quickly updating the value of a key. Bulk updates on these stores, such as modifying each key-value pair that satisfies a predicate, still require scanning entire tables and performing read-modify-write operations on each record, presenting the same high latency and possibly inconsistent state of the data.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of applying updates to a data set in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments include functionality to large, varied bulk operations in extremely large data stores in a way that seems immediate and consistent to readers while being asynchronous (and therefore non-blocking) to writers. For example, the bulk operations include bulk deletion, modification, and/or obfuscation of records in a data lake to delete all data pertaining to a member or asset, reducing the granularity of geographical information matching a predicate (e.g., within a time period), and/or otherwise modify personally identifiable information (PII) or other user data.

More specifically, the disclosed embodiments execute an asynchronous process that applies pending updates maintained in a registry to a data store on a periodic and/or continuous basis. For example, the registry stores mappings that identify portions of the data store, operations to be applied to the identified portions, use cases under which the updates are to be made, and/or other metadata related to the updates. The asynchronous process scans tables, datasets, partitions, and/or other portions of the data store; at a given portion, the asynchronous process uses mappings in the registry to retrieve pending updates for the portion and applies the pending updates to the portion. To expedite processing of the updates, the asynchronous process batches the updates before writing the updates. For example, the asynchronous process aggregates multiple row deletions in a table into a single delete statement that is executed against the table. After the asynchronous process applies a given update to a portion of the data store, the asynchronous process updates the registry with an indication that the update has been applied to the portion.

To ensure that reads of the data store are consistent with updates performed by the asynchronous process, read processes process read queries of the data store by applying pending updates from the registry to results of the read queries before returning the results in responses to the read queries. For example, a read process queries the registry for pending updates to a portion of a data store that is accessed during the read query. Such pending updates include updates that have not yet been applied to the portion by the asynchronous process and/or read-side filters that are used to modify read query results instead of persisting the modifications to the data store. The read process then rewrites the query to include “prepared statements” representing the pending updates before executing the read query. The read process also, or instead, applies the prepared statements to records in the data store during scanning of the records from a data source (e.g., table, partition, etc.) specified in the read query.

By combining asynchronous writes of bulk and/or pending updates to the data store with reads that separately apply the updates to read query results, the disclosed embodiments ensure that read queries of the data store are processed in a way that is consistent with the asynchronous writes, independently of the application of the updates to records in the data store. Such enforcement of consistency additionally scales with the size of the updates and/or data store because reads to the data store are not dependent on and/or synchronized with writes of the updates to the data store. Consequently, the disclosed embodiments improve computer systems, applications, tools, and/or technologies related to reading from, writing to, and/or maintaining consistency in datasets or data stores.

Asynchronous Bulk Data Updates with Read-Side Filtering

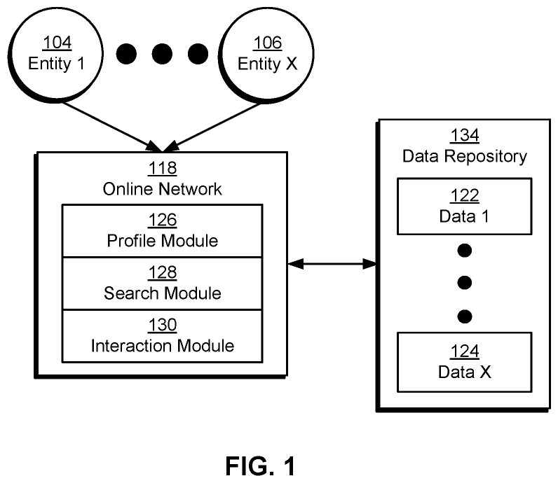

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

Those skilled in the art will appreciate that online network 118 may be required to update and/or transform data in data repository 134 for various reasons. For example, personally identifiable information (PII), geographical information, and/or all data pertaining to a member or asset in data repository 134 may be deleted, obfuscated, nulled, and/or otherwise transformed to reflect data-management policies for online network 118 and/or preferences of members of online network 118.

Those skilled in the art will also appreciate that data repository 134 may store large amounts of data for large numbers of members and/or entities in online network 118. For example, data repository 134 can include multiple petabytes (PB) of data related to the profiles and activities of hundreds of millions or billions of members and/or entities in online network 118. As a result, bulk updates to data in data repository 134 may be associated with significant latency, which can cause consistency issues with reads of data repository 134 and/or read-side latency from blocking of the reads during application of the bulk updates.

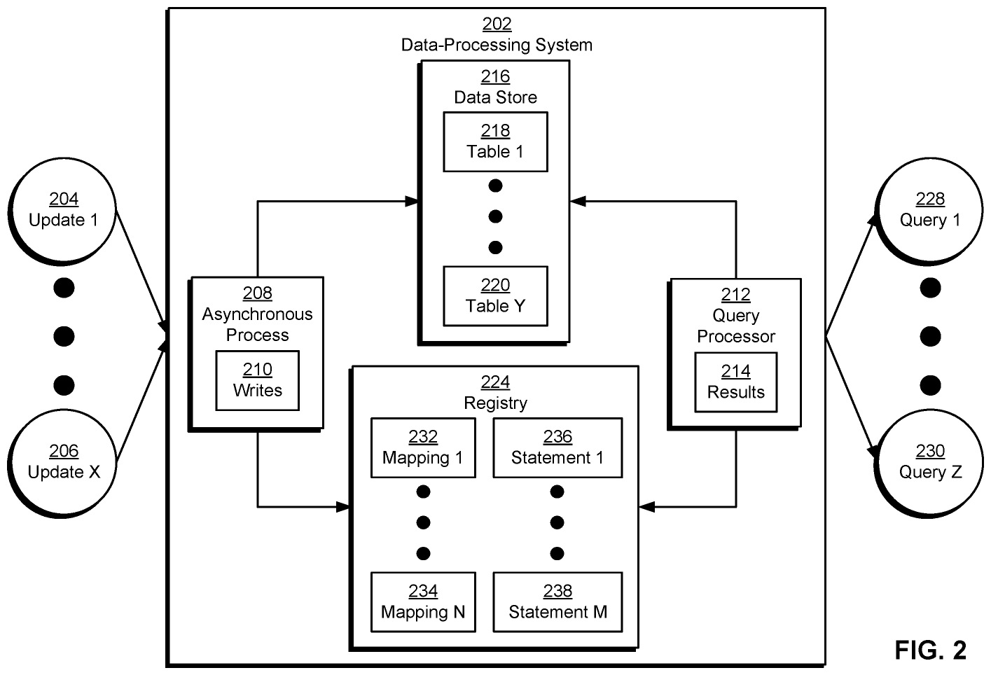

In one or more embodiments, data repository 134 and/or online network 118 include functionality to perform bulk data updates in a way that maintains consistency with reads of the data and avoids synchronization or blocking between the reads and writes. As shown in FIG. 2, a data-processing system 202 manages a data store 216 containing a number of tables (e.g., table 1 218, table y 220). Data store 216 includes, but is not limited to, a relational database, graph database, distributed filesystem, distributed streaming platform, service endpoint, data warehouse, data lake, change data capture (CDC) pipeline, and/or distributed data store. In some embodiments, data store 216 implements and/or provides data repository 134 of FIG. 1.

In one or more embodiments, data-processing system 202 includes functionality to apply a number of bulk updates (e.g., update 1 204, update x 206) to records and/or tables in data store 116. Such bulk updates include, but are not limited to, deletions, transformations, and/or obfuscations of fields, columns, records, tables, and/or other portions of data store 216.

For example, the bulk updates include deletions of records associated with member identifiers (IDs) in an online network (e.g., online network 118 of FIG. 1). In another example, the bulk updates include deletion of records associated with member IDs from datasets and/or tables containing search data. In a third example, the bulk updates include reducing the granularity of geographical information matching a member ID and/or another predicate.

In some embodiments, the bulk updates are specified and/or defined using statements (e.g., statement 1 236, statement m 238) that include Structured Query Language (SQL) expressions, rules, and/or user-defined functions (UDFs). The bulk updates are additionally associated with specific portions of data store 116 (e.g., databases, tables, rows, columns, keys, etc.) to which the corresponding deletions, obfuscations, and/or transformations are to be applied.

For example, one or more bulk updates to data store 116 are specified in a configuration file with the following format:

datasetRestrictionUrn: “urn:datasetGroup:ALL”
rules: {

“urn:useCase:<use_case_1>”: {

rowFilter: “<boolean SQL expression>”
columnTransformations: {

“column1”: “<SQL expression transforming column1>”
“column2”: “<SQL expression transforming column2>”
// etc.

}
udfs: {

udf_alias_1: “com.udfs.ads.MyUdf1”
udf_alias_2: “com.udfs.ads.MyUdf2”
// etc.

}

}
// rules for another use case
“urn:useCase:<use_case_2>”: {

rowFilter: “...”
columnTransformations: { ... }
udfs: { ... }

}
// etc.

}

The example format begins with a “datasetRestrictionUrn” attribute that specifies one or more datasets to which the updates apply. The attribute is followed by a Uniform Resource Name (URN) of “urn:datasetGroup:ALL,” which indicates that the updates apply to all datasets in data store 216. In general, the URN identifies one or more databases, tables, data platforms, environments, datasets, groups of datasets, and/or other subsets of data store 216 to be targeted by the updates.

The example format then specifies a set of “rules” that define the updates to be applied to the specified dataset(s). Within the rules, a “rowFilter” attribute is followed by a Boolean SQL expression that performs row-level filtering in data store 116. If the expression evaluates to “false” for a given row, the row is removed (e.g., deleted, filtered, hidden, etc.).

The rules also include a “columnTransformations” attribute. The attribute includes a list of column names (e.g., “column1,” “column2,” etc.), followed by corresponding SQL expressions that performs column-level transformations in data store 116.

For example, a SQL expression for nulling out records in a column named “coil” that are older than 90 days includes the following:

col1: “““CASE

WHEN timestamp < daysago_udf(90) THEN null
ELSE col1

END”””

In another example, a column transformation is defined for a nested field named “memberid” inside a struct named “header” using the following format:

“header.memberid”:“<transformation>”

In a third example, a column transformation is defined for a collection of columns, which can include columns of a certain data type, columns containing PII, custom column collections under which different sets of columns are grouped, and/or columns associated with other types and/or categories.

The rules can also include a “udfs” attribute. The attribute includes a list of UDF names or aliases followed by fully qualified names of the corresponding UDFs. After the UDFs are specified or defined in the file, the UDF aliases can be used with specific updates.

For example, the UDF with the alias of “udf_alias_1” can be specified for use with a row filter using the following:

rowFilter: “udf_alias_1 (foo, bar)”

In the above example, the UDF is invoked with parameters named “foo” and “bar.”

In another example, the UDf with the alias of “udf_alias_2” can be specified for use with a column transformation using the following:

columnTransformations: {

col1: “udf_alias_2(col1, header.memberid,

timestamp)”

}

In the above example, the UDF is invoked with parameters that include a column named “coil,” a nested field named “memberid” inside a struct named “header,” and a column named “timestamp.” In turn, the UDF is used to transform an original value in “coil” into a new value.

The example format above additionally includes instances of a “useCase” attribute that specifies use cases associated with the updates. A given “useCase” attribute can be assigned a predefined use case value. For example, predefined use case values include an “ALL” use case that results in permanent deletion or modification of data in data store 216, a read-side filtering use case that performs filtering or transformation of data in data store 216 during processing of read queries, and/or an obfuscation use case that produces a copy of a dataset with a subset of fields in the copy transformed using an obfuscation function (e.g., a function that transforms the fields into null, 0, or other non-meaningful values).

The “useCase” attribute alternatively or additionally identifies a custom use case to which rules grouped under the attribute are applied. The custom use case includes a list of IDs for users and/or other entities that access data store 216. For example, an “adsTargeting” use case includes IDs for accounts that perform reads of data store 216 to retrieve data that is subsequently used in ad targeting. As a result, rules grouped under the use case are identified as applicable when accounts listed under the use case in a different configuration file are used to access data store 216.

A more detailed example of a configuration file that adheres to the format discussed above includes the following:

datasetRestrictionUrn: “urn:datasetGroup:memberActions”

rules: {

“urn:useCase:ALL”: {

rowFilter: “““NOT join(

get_column_ref_for_type(‘MEMBER_ID’),
drop_data_requests( ))”””

columnTransformations: {

ipAddress: “““IF elapsed_days(

get_column_ref_for_type(‘EVENT_TIME’)) >
30 THEN drop_last_8_bits(ipAddress) ELSE
ipAddress”””

}
“urn:useCase:adsTargeting”: {

rowFilter: “““NOT join(

get_column_ref_for_type(‘MEMBER_ID’),
member_targeting_opt_out( ))”””

}
udfs: {

drop_last_8_bits: “com.udfs.DropLast8BitsUDF”

// etc.

}

}

The configuration file above includes a “datasetRestrictionUrn” attribute with a dataset value of “urn:datasetGroup:memberActions,” which indicates that the rules in the configuration file apply to a a group of datasets named “memberActions.” Next, the configuration file includes rules grouped under an “ALL” use case and an “adsTargeting” use case. The “ALL” use case indicates that updates specified under the use case apply to all accounts and/or users in the “memberActions” dataset group, and the “adsTargeting” use case indicates that the updates specified under the use case apply to accounts and/or users listed under the same use case in a different configuration file.

Under the “ALL” use case, the rules include a row-level filter that removes data associated with any member ID associated with a request to drop data. The rules also include a column-level transformation that drops the last 8 bits of an Internet Protocol (IP) address after 30 days. The column-level transformation is performed using a UDF with an alias of “drop_last_8_bits,” which maps to a corresponding fully qualified name of “com.udfs.DropLast8BitsUDF.”

Under the “adsTargeting” use case, the rules include a row-level filter that removes records associated with member IDs for members that have opted out of ads targeting. The row-level filter is applied whenever a process or account that falls under the “adsTargeting” use case is used to retrieve data from the “memberActions” dataset group.

In some embodiments, data-processing system 202 maintains a registry 224 that stores a list of pending updates to data store 216. For example, registry 224 includes one or more lookup tables that store IDs of members, jobs, schools, companies, articles, posts, and/or other entities for which all associated records are to be deleted from data store 216 (e.g., in response to account closures of the entities).

In another example, registry 224 includes one or more key-value stores that contain mappings (e.g., mapping 1 232, mapping n 234) among datasets, use cases, rules, lookup tables, statements, and/or other attributes related to the updates. When a user submits a new configuration, data-processing system 202 adds mappings to registry 224 to model the relationships among one or more datasets, use cases, updates, lookup tables, statements, and/or other attributes specified in the configuration. When a user modifies an existing configuration, data-processing system 202 updates mappings associated with the configuration in registry 224 to reflect the modifications. When a user deletes a configuration, data-processing system 202 removes mappings associated with the configuration from registry 224.

An asynchronous process 208 in data-processing system 202 applies a subset of updates in registry 224 as writes 210 to data store 216. During execution of asynchronous process 208, other processes and/or components are able to perform additional writes (e.g., in response to normal write queries) and reads to data store 216 without blocking or being blocked by asynchronous process 208.

More specifically, asynchronous process 208 continuously scans through tables (or other portions) of data store 216. During a scan of a given table, asynchronous process 208 retrieves mappings and/or configurations related to the table (e.g., mappings or configurations that include an ID for the table and/or a dataset containing the table) from registry 224. From the retrieved mappings and/or configurations, asynchronous process 208 identifies updates that include writes 210 to the table (e.g., updates associated with use cases that specify permanent modification of records in data store 216).

Asynchronous process 208 then performs writes 210 to a temporary copy of the table according to SQL expressions, UDFs, rules, and/or parameters specified in the mappings and/or configurations. For example, asynchronous process 208 generates copies of one or more files storing the table, retrieves one or more lists of entity IDs from lookup tables in registry 224, and deletes records associated with the entity IDs from the copied files. In another example, asynchronous process 208 modifies PII and/or other types of data in the copied files to null values, empty values, zero values, and/or other non-meaningful values.

To expedite execution of writes 210, asynchronous process 208 batches writes on rows, columns, and/or other portions of data in the table. For example, asynchronous process 208 batches entity IDs in a lookup table into a single operation that deletes records associated with the entity IDs from the table.

After writes 210 to the temporary copy are complete, asynchronous process 208 replaces the original table with the data in the copy. For example, asynchronous process 208 replaces files storing the original table with new files storing the copy that includes writes 210. If another process has updated the original table while writes 210 are performed, asynchronous process 208 omits substitution of the original table with the copy to ensure that the updates applied by the other process are maintained in data store 216.

Asynchronous process 208 also, or instead, maintains both the original version of the table and the copy of the table in data store 216. For example, asynchronous process 208 eeps both versions of the table in data store 216 to allow independent querying of unobfuscated data in the original table and obfuscated data in the copy (e.g., for subsequent processing of the queried data under different use cases).

After writes 210 are applied to a table and/or another portion of data store 216, asynchronous process 108 updates registry 224 and/or another data structure to indicate that the corresponding updates have been completed with respect to the portion. For example, asynchronous process 208 updates one or more mappings and/or records in registry 224 that correspond to writes 210 with a name and/or ID for the table to indicate that writes 210 have been applied to the table. In another example, asynchronous process 208 updates metadata related to the table to include IDs of updates represented by writes 210.

While asynchronous process 208 performs writes 210 that permanently apply a subset of updates in registry 224 to data store 216, a query processor 212 separately processes read queries (e.g., query 1 228, query z 230) of data store 216 in a way that applies the same updates and/or different updates in registry 224 to results 214 of the read queries. More specifically, query processor 212 ensures that results 214 are consistent with updates in registry 224 that represent pending writes 210 to data store 216, even if the pending writes 210 have not yet been performed by asynchronous process 208.

For example, query processor 212 uses mappings and/or records in registry 224 and/or another data structure to identify a subset of tables in data store 216 to which asynchronous process 208 has not performed writes 210. To ensure that processing of a read query is consistent with updates represented by writes 210, query processor 212 applies the updates to results 214 of the read query that are obtained from the subset of tables. As a result, query processor 212 and asynchronous process 208 are able to read and write to data store 216 without blocking or synchronizing with one another.

Such updates also, or instead, include read-side filters that remove, transform, and/or obfuscate records and/or fields in results 214 without persisting the same changes to data in data store 216. For example, the read-side filters include transformations and/or obfuscations of records and/or columns for members that opt out of ad targeting, marketing emails, and/or other use cases involving the members' PII and/or profile information. When a read-side filter is defined for a given table or portion of data store 216, query processor 212 applies the read-side filter to all read queries of the table or portion.

In one or more embodiments, query processor 212 uses statements in registry 224 to modify results 214 of read queries so that results 214 are consistent with pending or ongoing writes 210 to data store 216 by asynchronous process 208 and/or read-side filters in registry 224. More specifically, query processor 212 includes functionality to rewrite a read query so that the read query includes one or more statements from registry 224 that represent or implement writes 210 and/or read-side filters. Query processor 212 then executes the rewritten read query so that the writes and/or read-side filters are included in the result of the read query.

For example, query processor 212 omits records associated with closed accounts from a result of a read query of “SELECT * from T” by rewriting the read query to “SELECT * from T LEFT OUTER JOIN closed_accounts on (T.id=closed_accounts.id) WHERE closed_accounts.id IS NULL.” The rewritten query includes a statement of “LEFT OUTER JOIN closed_accounts on (T.id=closed_accounts.id) WHERE closed_accounts.id IS NULL,” which is appended to the original query to filter the records from the result. In other words, the rewritten query excludes, from the result, records in a dataset named “T” with values of “id” that are found in a “closed_accounts” table, where the “closed_accounts” table includes a list of entity IDs for closed accounts.

In another example, query processor 212 obfuscates or transforms values from a column containing PII, profile data, and/or another type of data for entities that have opted out from ad targeting using that type of data by rewriting the read query above to “SELECT * FROM T IF (opt_out.id IS NULL THEN T.col ELSE mask(T.col)) LEFT OUTER JOIN opt_out ON (T.id=opt_out.id).” The rewritten query includes a statement of “IF (opt_out.id IS NULL THEN T.col ELSE mask(T.col)) LEFT OUTER JOIN opt_out ON (T.id=opt_out.id),” which is appended to the original query to apply the obfuscation or transformation to the result of the read query. More specifically, the rewritten query causes a UDF named “mask” to be applied to a column named “col” in “T” when a record in “T” has a value of “id” that is found in an “opt_out” table, where the “opt_out” table includes a list of entity IDs for accounts that have opted out of ad targeting.

In a third example, query processor 212 removes activity histories from entities that have requested deletion of the activity histories from a result of the read query by rewriting the read query to “SELECT * FROM T LEFT OUTER JOIN delete_requests ON (T.id=delete_requests.id) WHERE delete_requests.id IS NULL OR dataset.timestamp>delete_requests.timestamp.” The rewritten query includes a statement of “LEFT OUTER JOIN delete_requests ON (T.id=delete_requests.id) WHERE delete_requests.id IS NULL OR dataset.timestamp>delete_requests.timestamp,” which is appended to the original query to remove the activity histories from the result. Thus, the rewritten query excludes, from the result, a record from “T” with a value of “id” that is also found in a “delete_requests” table when the timestamp of the record in “T” is older than the timestamp of a corresponding record in “delete_requests” with the same “id” value.

Query processor 212 also, or instead, applies updates in registry 224 during retrieval of records from a data set specified in a given query. For example, query processor 212 processes a read query that specifies one or more tables in a SQL “FROM” clause by sequentially scanning records in the table(s). During the scan of a given record, query processor 212 applies statements pertaining to relevant pending updates (e.g., deletions, obfuscations, transformations, etc.) to the record before executing remaining portions of the read query (e.g., additional filtering, ordering, joining, etc.).

Asynchronous process 208 and/or query processor 212 additionally include functionality to perform writes and reads of data store 216 according to priorities associated with the corresponding updates in registry 224. For example, asynchronous process 208 and/or query processor 212 apply rules and/or updates in registry 224 to the corresponding datasets according to an order of precedence, in which a more specific rule has a higher precedence than a less specific rule. Thus, a first rule that pertains to a specific data set and a specific use case has higher precedence than a second rule that pertains to a group of datasets and one or more use cases, and the second rule has higher precedence than a third rule that pertains to all datasets and all use cases. When registry 224 includes multiple conflicting rules at the same level of precedence, asynchronous process 208 and/or query processor 212 choose one of the rules to apply and/or generate an alert or exception related to the conflict.

In another example, rules and/or updates in registry 224 are associated with implicit or explicit priorities. Explicit priorities include, but are not limited to, numeric and/or other types of ratings that specify the importance of the corresponding rules and/or updates. Implicit priorities include, but are not limited to, an ordering of priorities for different use cases under which the rules and/or updates are grouped (e.g., certain types of updates are higher priority than other types of updates). During processing of a performance-sensitive read query, query processor 212 can choose to reduce read latency by applying only higher priority updates to the result of the read query.

By combining asynchronous writes of bulk and/or pending updates to the data store with reads that separately apply the updates to read query results, data-processing system 202 ensures that read queries of the data store are processed in a way that is consistent with the asynchronous writes, independently of the application of the updates to records in the data store. Such enforcement of consistency additionally scales with the size of the updates and/or data store because reads to the data store are not dependent on and/or synchronized with writes of the updates to the data store. Consequently, the disclosed embodiments improve computer systems, applications, tools, and/or technologies related to reading from, writing to, and/or maintaining consistency in datasets or data stores.

Those skilled in the art will appreciate that the system of FIG. 2 may be implemented in a variety of ways. First, data-processing system 202, data store 216, registry 224, asynchronous process 208, and/or query processor 212 may be provided by a single physical machine, multiple computer systems, one or more virtual machines, a grid, one or more databases, one or more filesystems, and/or a cloud computing system. Data-processing system 202, data store 216, registry 224, asynchronous process 208, and/or query processor 212 may additionally be implemented together and/or separately by one or more hardware and/or software components and/or layers. Multiple instances of asynchronous process 208, registry 224, and/or query processor 212 may be used to implement the functionality of the system across multiple machines, clusters, and/or partitions in data store 216.

Second, the functionality of the system may be used with various types of data and/or data stores. For example, asynchronous process 208 and query processor 212 may independently apply updates in registry 224 to relational databases, streaming data, flat files, distributed filesystems, images, audio, video, telemetry data, and/or other types of data.

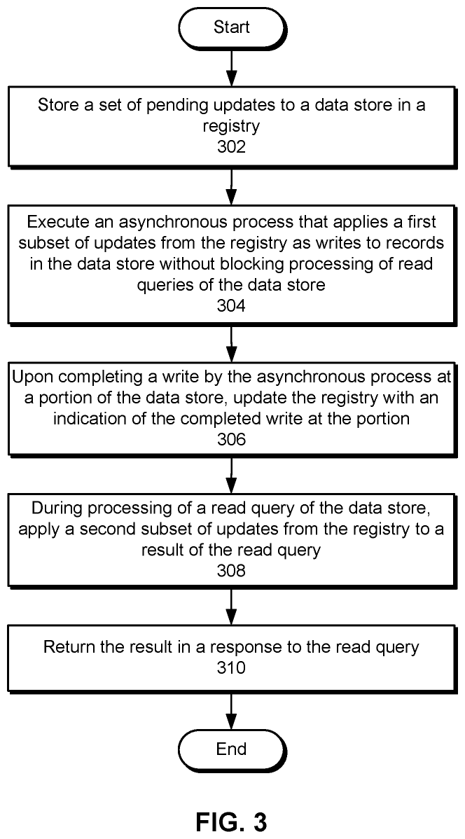

FIG. 3 shows a flowchart illustrating a process of applying updates to a data set in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of pending updates to a data store is stored in a registry (operation 302). For example, each pending update includes a type of update, such as a deletion of records from the data store, an obfuscation that produces a copy of records with a subset of fields in the copy transformed using an obfuscation function, and/or a read-side filter that modifies processing of read queries without modifying data persisted in the data store. Each pending update may be specified as a row filter, column transformation, SQL expression, UDF, and/or another type of change to data in the data store. Each pending update may also identify records, tables, datasets, entity IDs, data platforms, and/or other portions of the data store to which the pending updates apply. The registry includes mappings among datasets, use cases, updates, lookup tables, and/or other attributes related to the updates, as well as statements (e.g., SQL expressions, UDFs, etc.) that define and/or are used to apply the updates.

Next, an asynchronous process that applies a first subset of updates from the registry as writes to records in the data store without blocking processing of read queries of the data store is executed (operation 304). For example, the asynchronous process periodically, routinely, and/or continuously scans tables, data sets, partitions, and/or other portions of the data store. When a given portion of the data store is scanned, the asynchronous process matches the portion to one or more pending updates (e.g., using mappings of the portion's ID to the update(s) in the registry) and applies the pending updates (e.g., as a batch update to the portion).

Upon completing a write at a portion of the data store, the asynchronous process updates the registry with an indication of the completed write at the portion (operation 306). For example, the asynchronous process annotates one or more entries representing the write in the registry with a name and/or identifier of the portion.

During processing of a read query of the data store, a second subset of updates from the registry is applied to a result of the read query (operation 308). The second subset of updates may include read-side filters that are applied only during processing of read queries of the data store. The second subset of updates may also, or instead, include an update in the registry that has not been applied by the asynchronous process to the portion of the data store used to process the read query. The update may be identified based on indications generated by the asynchronous process of writes that have been completed and portions of the data store in which the writes have been completed. Conversely, when the asynchronous process has generated an indication that a given update has been applied to the portion of the data store accessed by the read query, the update is excluded from the second subset of updates.

To apply the second subset of updates to the result of the read query, the read query may be rewritten to include statements that produce the second subset of updates. Alternatively or additionally, the second subset of updates is applied to individual records in the data store during a scan of the records from a data source specified in the read query.

Finally, the result is returned in a response to the read query (operation 310). For example, the result is used in subsequent batch processing of data in the data store and/or used to generate output that is displayed to end users.

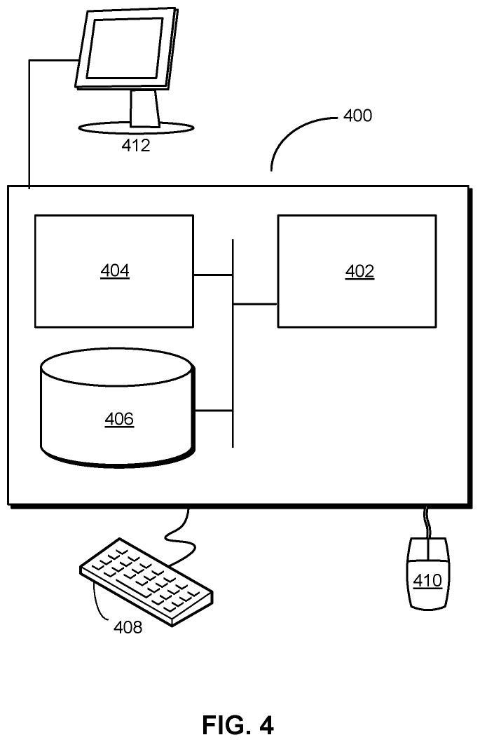

FIG. 4 shows a computer system 400. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for managing a data store. The system includes an asynchronous process, a query processor, and a registry. The registry stores a set of pending updates to a data store. The asynchronous process applies a first subset of updates from the registry as writes to records in the data store without blocking processing of read queries of the data store. Upon completing a write at a second portion of the data store, the asynchronous process updates the registry with an indication of the completed write at the second portion of the data store. During processing of a read query of the data store, the query processor applies a second subset of updates from the registry to a result of the read query. Finally, the query processor returns the result in a response to the read query

In addition, one or more components of computer system 400 may be remotely located and connected to the other components over a network. Portions of the present embodiments (e.g., data store, asynchronous process, query processor, registry, online network, etc.) may also be located on different nodes of a distributed system that implements the embodiments. For example, the present embodiments may be implemented using a cloud computing system that performs asynchronous updates and read-side filtering to a number of remote data sets and/or data stores.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
storing a set of pending updates to a data store in a registry, wherein a first update in the set of pending updates comprises a type of update and a first portion of the data store to which the first update applies;
executing, by one or more computer systems, an asynchronous process that applies a first subset of updates from the registry as writes to records in the data store without blocking processing of read queries of the data store;
upon completing a write by the asynchronous process at a second portion of the data store, updating the registry with an indication of the completed write at the second portion of the data store;
during processing of a read query of the data store, applying a second subset of updates from the registry to a result of the read query; and
returning the result in a response to the read query.

2. The method of claim 1, wherein applying a first subset of updates from the registry as writes to the records in the data store comprises:
performing a scan of the data store; and
when the scan reaches a third portion of the data store, matching the portion to one or more pending updates associated with writing to the third portion in the registry; and
applying the one or more pending updates to the third portion.

3. The method of claim 2, wherein applying the one or more pending updates to the third portion comprises:
performing the one or more pending updates as a batch update to the third portion.

4. The method of claim 1, wherein applying the second subset of updates from the registry to the result of the read query comprises:
omitting, based on the indication of the completed write at the second portion of the data store, application of an update represented by the write to the second portion of the data store.

5. The method of claim 1, wherein applying the second subset of updates from the registry to the result of the read query comprises:
rewriting the read query to include the second subset of updates.

6. The method of claim 1, wherein applying the second subset of updates from the registry to the result of the read query comprises:
applying the second subset of updates to the records during a scan of records from a data source specified in the read query.

7. The method of claim 1, wherein the type of update comprises at least one of:
a deletion of a first record from the data store;
an obfuscation that produces a copy of a second record with a subset of fields in the copy transformed using an obfuscation function; and
a read-side filter that modifies processing of read queries without modifying data persisted in the data store.

8. The method of claim 1, wherein the portion of the data store to which the first update applies comprises at least one of:
a table;
a dataset;
a data platform;
an entity identifier; and
a column name.

9. The method of claim 1, wherein the pending update further comprises a use case representing one or more entities that access the data store.

10. The method of claim 1, wherein the data store comprises a distributed filesystem.

11. The method of claim 1, wherein the set of pending updates comprises at least one of:
a row filter;
a column transformation; and
a user-defined function (UDF).

12. A system, comprising:
one or more processors; and
memory storing instructions that, when executed by the one or more processors, cause the system to:
store a set of pending updates to a data store in a registry, wherein a first update in the set of pending updates comprises a type of update and a first portion of the data store to which the first update applies;
during processing of a read query of a second portion of the data store, identifying, based on tracking data that indicates writes in the registry that have been completed and portions of the data store in which the writes have been completed, an update in the registry that has not been written to the second portion of the data store;
applying the update to a result of the read query; and
returning the result in a response to the read query.

13. The system of claim 12, wherein the memory further stores instructions that, when executed by the one or more processors, cause the system to:
execute the asynchronous process that applies a second subset of updates from the registry as writes to records in the data store without blocking processing of the read query; and
upon completing a write by the asynchronous process at a third portion of the data store, updating the registry with an indication of the completed write at the third portion of the data store.

14. The system of claim 13, wherein applying the second subset of updates from the registry as writes to the records in the data store comprises:
performing a scan of the data store; and
when the scan reaches a third portion of the data store, matching the third portion to one or more pending updates associated with writing to the third portion in the registry; and
applying the one or more pending updates to the third portion.

15. The system of claim 12, wherein applying the second subset of updates from the registry to the result of the read query comprises at least one of:
rewriting the read query to include the second subset of updates; and
applying the second subset of updates to the records during a scan of records from a data source specified in the read query.

16. The system of claim 12, wherein the type of update comprises at least one of:
a deletion of a first record from the data store;
an obfuscation that produces a copy of a second record with a subset of fields in the copy transformed using an obfuscation function; and
a read-side filter that modifies processing of read queries without modifying data persisted in the data store.

17. The system of claim 12, wherein the pending update further comprises a use case representing one or more entities that access the data store.

18. The system of claim 12, wherein the set of pending updates comprises at least one of:
a row filter;
a column transformation; and
a user-defined function (UDF).

19. A non-transitory computer-readable storage medium storing instructions that when executed by a computer cause the computer to perform a method, the method comprising:
storing a set of pending updates to a data store in a registry, wherein a first update in the set of pending updates comprises a type of update and a first portion of the data store to which the first update applies;
executing an asynchronous process that applies a first subset of updates from the registry as writes to records in the data store without blocking processing of read queries of the data store;
upon completing a write by the asynchronous process at a second portion of the data store, updating the registry with an indication of the completed write at the second portion of the data store;
during processing of a read query of the data store, applying a second subset of updates from the registry to a result of the read query; and
returning the result in a response to the read query.

20. The non-transitory computer-readable storage medium of claim 19, wherein the registry comprises:
mappings among attributes associated with the pending updates; and
statements used to apply the pending updates.
